(19) United States
(12) Patent Application Publication
(10) Pub. No.: US 2008/0013911 A1
(43) Pub. Date: Jan. 17, 2008

(54) Homogenized beam shaper

(75) Inventor: Dean Jennings, Beverly, MA (US)

Correspondence Address: TOWNSEND AND TOWNSEND AND CREW LLP / AMAT, TWO EMBARCADERO CENTER, EIGHTH FLOOR, SAN FRANCISCO, CA, 94111-3834, US

(73) Assignee: Applied Materials, Inc., Santa Clara, CA (US)

(21) Appl. No.: 11/480,135

(22) Filed: Jun. 30, 2006

(51) Int. Cl. G02B 6/10

(52) U.S. Cl. 385/146

(57) ABSTRACT

A beam shaper has a light pipe fabricated of a material having a refractive index that provides total internal reflection within the light pipe. A first face accepts light and a second face releases light from the light pipe. The faces are orthogonal to an axis about which the light pipe is twisted and have different shapes. The area of the second face differs from an area of the first face by less than 25%.

### BACKGROUND OF THE INVENTION

There are a number of applications in which it is desirable to provide a beam of light that has a certain size and shape. This is conventionally done with an optical train that includes some combination of focusing elements like lenses or mirrors, collimation elements like lenses or mirrors, and the like. Light is incident at one end of the optical train, is shaped by the elements comprised by the optical train, and emerges from the other end of the optical train in the desired shape.

There are a number of instances in which physical limitations limit the ability to shape a beam of light. One physical limitation is imposed by the inability of any optical system to increase etendue, which is defined as the product of the cross-sectional area of a cone of light (in the plane orthogonal to its direction of propagation) with the solid angle subtended by the light. The effect of this physical limitation is illustrated in FIG. 1.

For instance, one might suppose that a technique for generating a narrow elongated beam of light might be to provide light 104 from a source to a light pipe 100 tapered to decrease in cross-sectional area along its length. Light within the light pipe 100 would propagate by total internal reflection and emerge at the narrow end effectively as a point source 108 that could then be collimated to provide the desired shape. But if the etendue at the outlet is the same as the etendue at the inlet, then

A₂ sin θ₂=A₁ sin θ₁,

where A₁ and A₂ are respectively the cross-section areas of the input and output ends of the light pipe 100 and θ₁ and θ₂ are respectively the incidence angle of the beam at the input and output of the light pipe. The light cone 108 emerging from the outlet of the light pipe 100 is thus defined by

$${θ}_{2} = {sin}^{- 1} ( \frac{{A}_{1}}{{A}_{2}} sin {θ}_{1} ) .$$

For any significant taper where A₁>>A₂, the argument of the arcsin function exceeds unity so that there is no angle at which the light can emerge. The light will reflect internally to the light pipe 100 and re-emerge from the same end where it was input.

There is accordingly a general need in the art for improved optical beam-shaping structures.

### BRIEF SUMMARY OF THE INVENTION

Embodiments of the invention provide beam shapers and methods for shaping beams that may be used in a variety of different applications. In a first set of embodiments, a beam shaper comprises a light pipe fabricated of a material having a refractive index that provides total internal reflection within the light pipe. A first face of the light pipe accepts light into the light pipe. The first face has a first shape and is disposed substantially orthogonal to an axis of the light pipe. A second face of the light pipe releases light from the light pipe. The second face has a second shape substantially different from the first face and is also disposed substantially orthogonal to the axis of the light pipe. An area of the second face differs from an area of the first face by less than 25%. The light pipe is twisted about the axis.

In some of these embodiments, the area of the second face differs from the area of the first face by less than 10%. The area of the second face may be substantially equal to the area of the first face.

In some embodiments, the first shape is substantially a circle. Examples of second shapes include a polygon and a narrow rectangle. In one specific embodiment where the first shape is circular and the second shape is rectangular, the circle has a diameter of approximately 1 mm and the rectangle is approximately 8 mm×100 μm, with the light pipe having a length greater than 500 mm.

The axis of the light pipe may be substantially linear. In one embodiment, the light pipe has an average twist about the axis between 15 degrees/meter and 75 degrees/meter. In other embodiments, the light pipe has a length greater than 100 times a square root of the area of the first face, or has a length greater than 500 times the square root of the area of the first face.

In a second set of embodiments, methods are provided of shaping a beam of illumination. Light is directed into a light pipe at a first face of the light pipe. The first face has a first shape and is disposed substantially orthogonal to an axis of the light pipe. The directed light is propagated by total internal reflection through the light pipe to a second face of the light pipe. The second face has a second shape substantially different from the first face and is disposed substantially orthogonal to the axis of the light pipe. The propagated light is allowed to emanate from the second face. An area of the first face differs from an area of the second face by less than 25%. The light pipe is twisted about the axis.

Variations described in connection with the first set of embodiments may apply also to the second set of embodiments.

In a third set of embodiments, a method is provided of thermally processing a substrate. Electromagnetic radiation is directed into a light pipe at a substantially circular first face of the light pipe. The first face is disposed substantially orthogonal to an axis of the light pipe. The light pipe is twisted about the axis. The directed electromagnetic radiation is propagated by total internal reflection through the light pipe to a narrow rectangular second face of the light pipe. The second face has an area substantially equal to an area of the first face and is disposed substantially orthogonal to the axis of the light pipe. The propagated electromagnetic radiation is allowed to emanate from the second face as a line of electromagnetic radiation extending partially across a surface of the substrate. The line of electromagnetic radiation is translated relative to the surface such that every exposed point of the surface has a substantially homogeneous thermal exposure.

In a fourth set of embodiments, an apparatus is provided for thermally processing a substrate. The apparatus comprises a source of electromagnetic radiation, a stage disposed to support a substrate, and an optical arrangement. The optical arrangement is disposed to direct electromagnetic radiation from the source to the substrate. It comprises a light pipe fabricated of a material having a refractive index that provides total internal reflection within the light pipe. A substantially circular first face of the light pipe accepts the electromagnetic radiation into the light pipe. The first face is disposed substantially orthogonal to an axis of the light pipe. The light pipe is twisted about the axis. A narrow rectangular second face of the light pipe releases light from the light pipe. The second face has an area substantially equal to an area of the first face and is disposed substantially orthogonal to the axis of the light pipe.

### BRIEF DESCRIPTION OF THE DRAWINGS

A further understanding of the nature and advantages of the present invention may be realized by reference to the remaining portions of the specification and the drawings wherein like reference numerals are used throughout the several drawings to refer to similar components. In some instances, a sublabel is associated with a reference numeral and follows a hyphen to denote one of multiple similar components. When reference is made to a reference numeral without specification to an existing sublabel, it is intended to refer to all such multiple similar components.

FIG. 1 provides a schematic illustration of a tapered light-pipe structure having a smaller output cross-sectional area than input cross-sectional area;

FIG. 2 illustrates a structure of a beam shaper according to an embodiment of the invention;

FIG. 3 shows an output beam produced by the beam structure of FIG. 2;

FIG. 4 shows a side view of an apparatus for thermal processing of a substrate that uses the beam shaper of FIG. 2;

FIG. 5 shows a top view of a substrate being processed with the apparatus of FIG. 4; and

FIG. 6 shows a side view of another apparatus for thermal processing of a substrate.

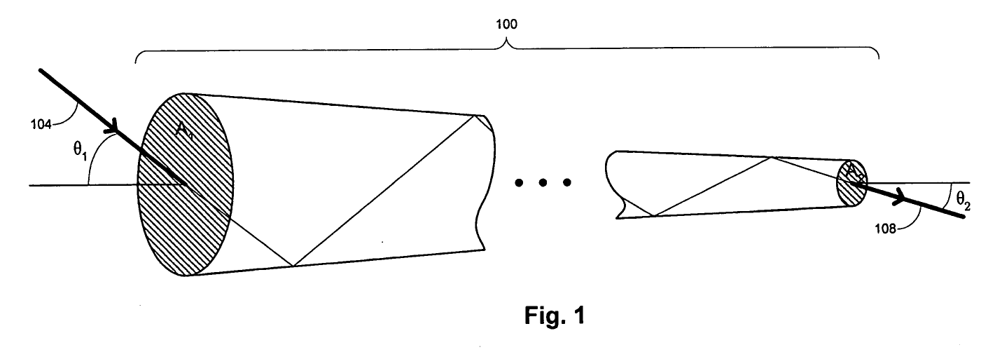

### DETAILED DESCRIPTION OF THE INVENTION

Embodiments of the invention provide a beam shaper that substantially conserves etendue. The beam shaper may generally comprise light pipe fabricated of a material having a refractive index that provides for total internal reflection of light input at a first end of the light pipe. Examples of suitable materials include plastic and glass, among others that will be known to those of skill in the art. Noncollimated light provided to an input face of the light pipe propagates by total internal reflection to an output face of the light pipe. The input and output faces have respective cross-sectional areas that differ by a limited amount, the difference being less than 25%, less than 20%, less than 15%, less than 10%, less than 5%, less than 4%, less than 3%, less than 2%, less than 1%, less than 0.5%, less than 0.1%, less than 0.05%, and less than 0.01% in various different embodiments. In certain embodiments, the cross-sectional area of the output face is substantially equal to the cross-sectional area of the input face. Deviations in the cross-sectional areas may be manifested by variations in the numerical aperture at the output face of the light pipe.

According to embodiments of the invention, the input and output faces of the light pipe have substantially different shapes. As used herein, the term “shape” refers to the cross-sectional configuration of the input or output without regard to its size; thus two circles of substantially different radii are considered to have the same shape, as are two regular N-sided polygons even when each of the N segments in the two polygons are of substantially different lengths. Examples of shapes that are different include a circle and a quadrilateral, a circle and a regular polygon, a regular N₁-sided polygon and an irregular NA′₂-sided polygon for different N₁ and N₂, and the like.

The light pipe may also be twisted along an axis extending from the input face to the output face. While it is generally anticipated that the twist will be substantially uniform along the axis, this is not a requirement of the invention and the twist may sometimes be variable. In certain specific embodiments, the average twist is between 15 and 75 degrees/meter or is between 30 and 60 degrees/meter. The twist generally permits energy to be spread out from the narrow direction of the light pipe into the longer direction. Also, the axis from the input face to the output face may sometimes be linear, but this is also not a requirement of the invention. In certain alternative embodiments, the axis includes one or more bends and/or is generally arcuate.

The length of the axis may also vary in different embodiments, although the inventor has discovered that losses are minimized by having a sufficiently long axis in combination with a twist of the light pipe along the axis. The combination of the axis length with the twist also results in substantial homogenization of the light emanating from the output face. In some embodiments, the axis has a length greater than 10 times the square root of the cross-sectional area of the input face, greater than 25 times the square root of the cross-sectional area of the input face, greater than 50 times the square root of the cross-sectional area of the input face, greater than 75 times the square root of the cross-sectional area of the input face, greater than 100 times the square root of the cross-sectional area of the input face, greater than 250 times the square root of the cross-sectional area of the input face, greater than 500 times the square root of the cross-sectional area of the input face, greater than 1000 times the square root of the cross-sectional area of the input face, greater than 2500 times the square root of the cross-sectional area of the input face, greater than 5000 times the square root of the cross-sectional area of the input face, or greater than 10,000 times the square root of the cross-sectional area of the input face.

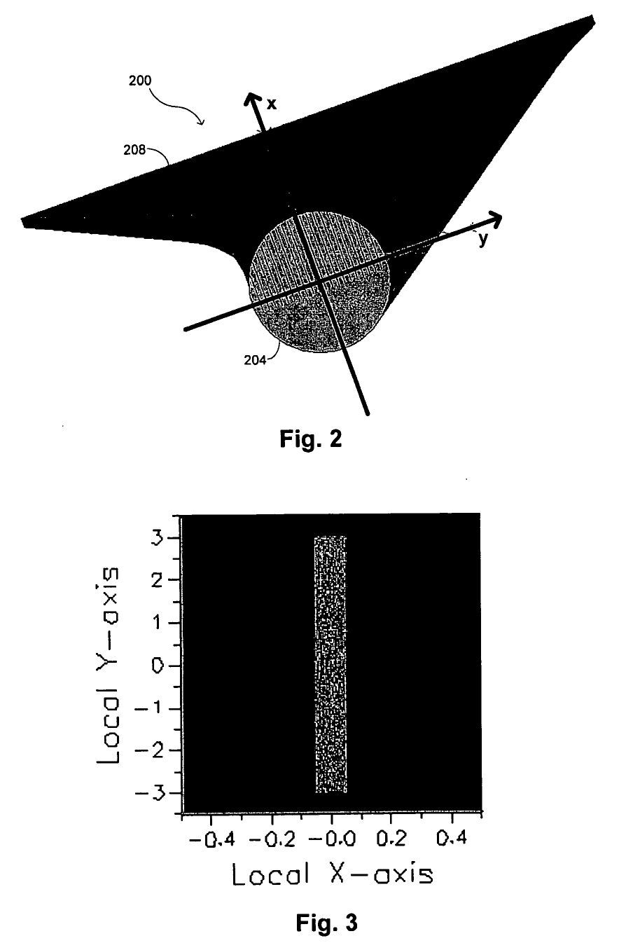

An illustration of a specific beam shaper in one embodiment of the invention is shown in FIG. 2. The illustration is for a beam shaper 200 having an input face 204 with a circular cross section and an output face 208 with a rectangular cross section separated along a linear axis of the beam shaper 200. The structure includes a twist along the axis, with the drawing showing a view looking down the length of the axis from the input face 204. In one exemplary embodiment, the circular input face has a diameter of 1 mm and the output face has dimensions of 8 mm×100 μm, with the axis having a length of 500 mm. With such a configuration, the cross-sectional area of the input face is about 0.785 mm², substantially equal to the 0.8 mm² area of the output face by having a difference in cross-sectional areas of only 1.88%. The 500-mm length of the axis is about 800 times the square root of the cross-sectional area of the input face 204.

Results of a simulation of the output of the beam shaper of FIG. 2 are shown in FIG. 3. In this illustration, noncollimated light was provided to the input face 204, with FIG. 3 showing the rectangular distribution of the beam that emanates from the output face 208. Advantageously, the irradiance at the output face 208 is substantially homogenized, as evident from the speckled nature of the results shown in FIG. 3. Results of the simulation show a numerical aperture of less than 0.25 in the fast direction at the output face 208.

A number of different ways may be used to fabricate a beam shaper of the type described above. For example, conventional flame-hydrolysis techniques may sometimes be used, with the shaping of the input and output faces, as well as introduction of the twist structure being accomplished while the light-pipe material is at an elevated temperature. The shaping process may sometimes result in surface roughening of the structure. In one test performed by the inventor, an unshaped plastic fiber transmitted 0.95 m W as compared with a transmission of 0.88 m W for a beam shaper fabricated as illustrated in FIG. 2 and with the specific dimensions of the exemplary embodiment described above.

### EXAMPLE

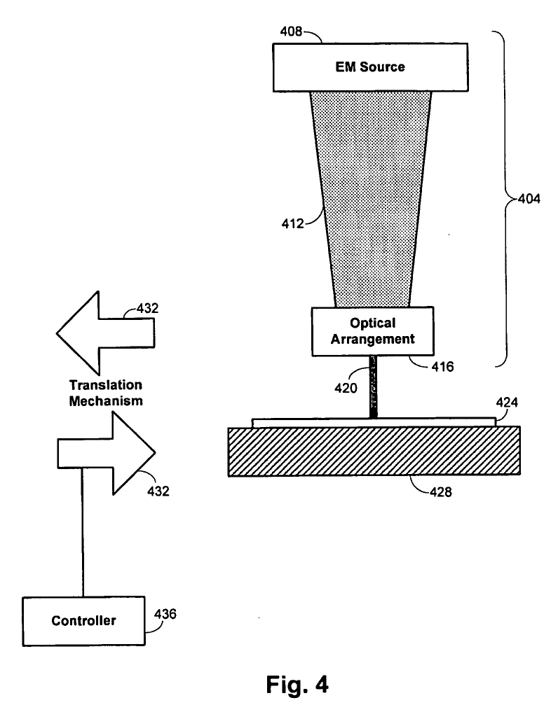

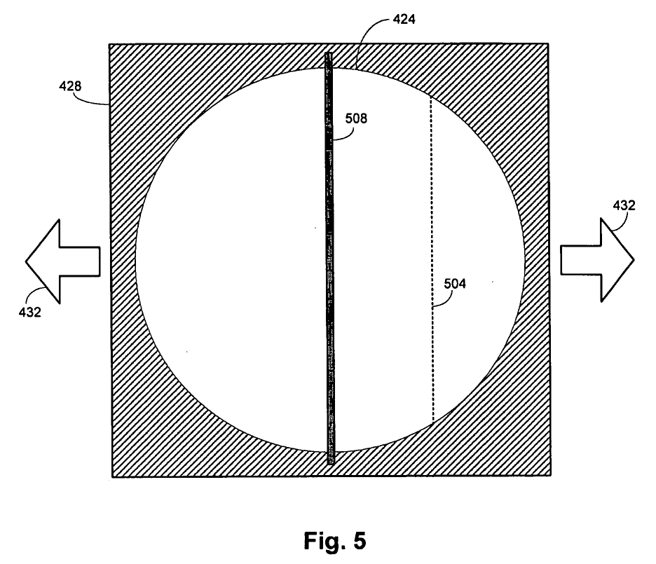

While different embodiments of the invention may find a number of different uses wherever shaped beams are desirable, the following specific illustration provides an example of an application where the beam shaper is used to provide a narrow rectangular beam. This example is realized in applications for thermally processing a substrate, such as in thermal annealing processes or in chemical-vapor-deposition processes that use thermal processes. A general structure of an apparatus that may be used for such thermal processes is illustrated schematically in FIG. 4. The apparatus comprises an electromagnetic radiation module 404, a stage 428 adapted to receive a substrate 424, and a translation mechanism 432.

The electromagnetic radiation module 404 comprises an electromagnetic source 408 that produces illumination 412 that is shaped by an optical arrangement 416 to generate a narrow elongated beam 420 as a line of radiation incident on the substrate 424. The electromagnetic source 408 may advantageously comprise a continuous electromagnetic source that generates the illumination 412 continuously for a period of time that exceeds 15 seconds. Suitable wavelengths for the illumination 412 in specific embodiments are between 190 and 950 nm, with a particular application using illumination 412 at 808 nm. To shape the illumination 412 into the narrow elongated beam 420, the optical arrangement may comprise a beam shaper having the structure described above.

The stage 428 may comprise a chuck or other mechanism for securing holding the substrate 424 during processing For instance, in some embodiments, a frictional, gravitational, mechanical, and/or electrical system is provided for grasping the substrate 424. The translation mechanism 432 is configured to translate the stage 428 and the beam 420 relative to each other, through movement of the stage 428, movement of the electromagnetic radiation module 404, or movement of both. Any suitable translation mechanism may be used, including a conveyor system, rank-and-pinion system, or the like. The translation mechanism 432 is operated by a controller 436 to define the scan speed of the line of radiation relative to the stage 428.

A more detailed description of the specific structures that may be used in implementing the thermal processing apparatus in FIG. 4 and of various alternative and equivalent variations to such a structure, is provided in published PCT application WO 03/089,184, the entire disclosure of which is incorporated herein by reference for all purposes.

FIG. 5 provides a top view of the substrate 424 overlying the stage 428. The line of radiation 508 provided by the narrow elongated beam 420 preferably extends across the entire diameter of the substrate 424. In certain embodiments, the geometry of the electromagnetic radiation module 404 and translation mechanism 432 are such that the line of radiation 508 traverses the substrate 424 in a direction perpendicular to its length, i.e. the line 508 remains parallel to a fixed chord 504 of the substrate 424.

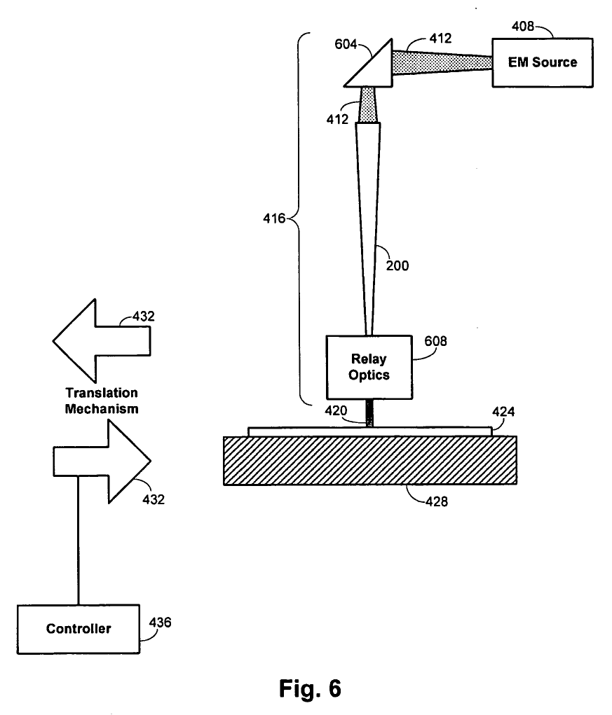

FIG. 6 illustrates certain details of the optical arrangement 416 as they may be provided in certain embodiments. In this illustration, a prism 604 is used to redirect the illumination emanating from the electromagnetic source 408. The illumination is directed into one or more beam shapers 200, which translate the illumination and configure the light into an elongated beam as described above. Relay optics 608 are provided to image the output face of the beam shapers 200 onto the substrate 424. In some instances, a plurality of beam shapers 200 arranged as a linear array are used to transmit the light and provide a line of radiation 508 having a sufficient total length. For instance, the exemplary beam shaper 200 described above provides a beam having a width of 100 μm, which is well suited for the thermal processing applications, with a length of 8 mm. For a substrate 424 having a diameter of 200 mm, an array having more than 25 beam shapers 200 may be used to provide the line of radiation 508; for a substrate 424 having a diameter of 300 mm, an array having more than 38 beam shapers 200 may be used to provide the line of radiation 508. The number of optical beam shapers 200 may be varied by providing structures having larger-area input faces, permitting larger-area output faces, with some embodiments having only a single beam shaper 200 when the input face has a sufficiently large area.

While this example provides an illustration of an application that makes use of a rectangularly shaped beam, it will be appreciated that other applications will occur to those of skill in the art that use differently shaped beams, such as other irregular polygonal structures, regular polygonal structures, elliptical structures; any planar shape may be provided by suitable construction of the shape of the output face.

Having described several embodiments, it will be recognized by those of skill in the art that further modifications, alternative constructions, and equivalents may be used without departing from the spirit of the invention. Accordingly, the above description should not be taken as limiting the scope of the invention, which is defined in the following claims.

What is claimed is:

1. A beam shaper comprising:
a light pipe fabricated of a material having a refractive index that provides total internal reflection within the light pipe, wherein the light pipe is twisted about an axis of the light pipe;
a first face of the light pipe for accepting light into the light pipe, the first face having a first shape and disposed substantially orthogonal to the axis of the light pipe; and
a second face of the light pipe for releasing light from the light pipe, the second face having a second shape substantially different from the first face and disposed substantially orthogonal to the axis of the light pipe,
wherein an etendue at the second face is substantially equal to an etendue at the first face.

2. The beam shaper recited in claim 1 wherein an area of the second face is substantially equal to an area of the first face.

3. The beam shaper recited in claim 1 wherein the first shape is substantially a circle.

4. The beam shaper recited in claim 3 wherein the second shape is a polygon.

5. The beam shaper recited in claim 4 wherein the second shape is a narrow rectangle.

6. The beam shaper recited in claim 5 wherein:
the circle has a diameter of approximately 1 mm;
the rectangle is approximately 8 mm×100 μm; and
the light pipe has a length greater than 500 mm.

7. The beam shaper recited in claim 1 wherein the axis is substantially linear.

8. The beam shaper recited in claim 1 wherein the light pipe has an average twist about the axis between 15 degrees/meter and 75 degrees/meter.

9. The beam shaper recited in claim 1 wherein the light pipe has a length greater than 100 times a square root of the area of the first face.

10. The beam shaper recited in claim 1 wherein the light pipe has a length greater than 500 times a square root of the area of the first face.

11. A beam shaper comprising:
a light pipe fabricated of a material having a refractive index that provides total internal reflection within the light pipe;
a substantially circular first face of the light pipe for accepting light into the light pipe, the first face disposed substantially orthogonal to an axis of the light pipe; and
a narrow rectangular second face of the light pipe for releasing light from the light pipe, the second face disposed substantially orthogonal to the axis of the light pipe,
wherein:
the light pipe is twisted about the axis
an area of the first face is substantially equal to an area of the second face;
the axis is substantially linear;
the light pipe has a length greater than 500 times a square root of the area of the first face; and
an etendue at the second face is substantially equal to an etendue at the first face.

12. A method of shaping a beam of illumination, the method comprising:
directing light into a light pipe at a first face of the light pipe, the first face having a first shape and disposed substantially orthogonal to an axis of the light pipe;
propagating the directed light by total internal reflection through the light pipe to a second face of the light pipe, the second face having a second shape substantially different from the first face and disposed substantially orthogonal to the axis of the light pipe; and
allowing the propagated light to emanate from the second face,
wherein:
the light pipe is twisted about the axis; and
an etendue at the second face is substantially equal to an etendue at the first face.

13. The method recited in claim 12 wherein an area of the second face is substantially equal to an area of the first face.

14. The method recited in claim 12 wherein the first shape is substantially a circle.

15. The method recited in claim 14 wherein the second shape is a narrow rectangle.

16. The method recited in claim 12 wherein the axis is substantially linear.

17. The method recited in claim 12 wherein the light pipe has an average twist about the axis between 15 degrees/meter and 75 degrees/meter.

18. The method recited in claim 12 wherein the light pipe has a length greater than 100 times a square root of the area of the first face.

19. A method of thermally processing a substrate, the method comprising:
directing electromagnetic radiation into a light pipe at a substantially circular first face of the light pipe, the first face disposed substantially orthogonal to an axis of the light pipe, wherein the light pipe is twisted about the axis;
propagating the directed electromagnetic radiation by total internal reflection through the light pipe to a narrow rectangular second face of the light pipe, the second face having an area substantially equal to an area of the first face and disposed substantially orthogonal to the axis of the light pipe;
allowing the propagated electromagnetic radiation to emanate from the second face as an elongated beam of electromagnetic radiation;
imaging the elongated beam as a line of electromagnetic radiation extending partially across a surface of the substrate; and
translating the line of electromagnetic radiation relative to the surface such that every exposed point of the surface has a substantially homogeneous thermal exposure.

20. An apparatus for thermally processing a substrate, the apparatus comprising:
a source of electromagnetic radiation;
a stage disposed to support a substrate;
an optical arrangement disposed to direct electromagnetic radiation from the source to the substrate, the optical arrangement comprising:
a light pipe fabricated of a material having a refractive index that provides total internal reflection within the light pipe;
a substantially circular first face of the light pipe for accepting the electromagnetic radiation into the light pipe, the first face disposed substantially orthogonal to an axis of the light pipe, wherein the light pipe is twisted about the axis;
a narrow rectangular second face of the light pipe for releasing light from the light pipe, the second face having an area substantially equal to an area of the first face and disposed substantially orthogonal to the axis of the light pipe; and
relay optics disposed between the second face and the stage to image the released light onto the substrate.
